(19) United States
(12) Patent Application Publication
(10) Pub. No.: US 2025/0303269 A1
(43) Pub. Date: Oct. 2, 2025

(54) CHALKBOARD BASED PUZZLE WITH PRINTABILITY FEATURE IN INDENTED SPACES

(71) Applicant: Creative Beginning Inc., Stouffville (CA)

(72) Inventor: Christina Collura, Stouffville (CA)

(21) Appl. No.: 19/096,936

(22) Filed: Apr. 1, 2025

Related U.S. Application Data
(60) Provisional application No. 63/572,827, filed on Apr. 1, 2024.

(51) Int. Cl. A63F 9/10; A63F 9/06; G09B 11/04

(52) U.S. Cl. CPC A63F 9/10; A63F 9/0666; G09B 11/04

(57) ABSTRACT

Provided herein are apparatuses and methods for re-usably printable puzzles. A chalkboard-based puzzle apparatus comprises a base including an indented layer comprising a board having a plurality of indented spaces, wherein each indented space has a flat bottom surface comprising a printable chalkboard material for writing upon with chalk or a chalk-like writing implement, and a plurality of puzzle pieces, wherein each puzzle piece is sized and shaped to match one of the plurality of indented spaces, such that each puzzle piece fits into a respective indented space. In an embodiment the indented spaces are cutouts through to a printable layer. In another embodiment, the indented spaces are indentations with a bottom surface comprising a printable material. The chalkboard-based puzzle apparatus may include the chalk or chalk-like writing implement and may include an eraser or cloth.

### TECHNICAL FIELD

The embodiments disclosed herein relate to educational toys and, in particular to puzzle toys for teaching users to write or draw.

### INTRODUCTION

Puzzles are popular recreational activities that challenge individuals' cognitive abilities and problem-solving skills. They offer children a plethora of benefits, encompassing cognitive, linguistic, social, and emotional development. Traditional puzzles typically involve assembling interlocking pieces to form a complete image or pattern. However, there is a need for innovation in the puzzle industry to enhance educational user engagement for identification of the interlocking puzzle pieces, for example, identification of letters and numbers beyond merely matching shapes.

As well, there is a need to address fine motor challenges children with and without special needs, in particular with printing or writing letters and numbers.

Therefore, it would be beneficial to provide a platform for both successful printing and identification. Accordingly, there is a need for educational toys which allow a user to both identify puzzle pieces and to interact with the puzzle pieces by printing.

### SUMMARY

Provided herein is a chalkboard-based puzzle apparatus comprising a base including an indented layer comprising a board having a plurality of indented spaces, wherein each indented space has a flat bottom surface comprising a printable chalkboard material for writing upon with chalk or a chalk-like writing implement, and a plurality of puzzle pieces, wherein each puzzle piece is sized and shaped to match one of the plurality of indented spaces, such that each puzzle piece fits into a respective indented space.

The plurality of indented spaces may comprise indentations in the indented layer, wherein each indentation is a depressed area which can receive a respective puzzle piece of the plurality of puzzle pieces. The bottom surface of each indentation may be coated with a chalkboard material. The bottom surface of each indentation may comprise an insert of chalkboard material.

The plurality of indented spaces may comprise cutouts through the indented layer, wherein the base of the puzzle further includes a printable layer comprising a chalkboard material which is connected to the indented layer such that the printable layer comprises the bottom surface of the plurality of indented spaces, and the printable layer is accessible for writing upon through the cutouts of the indented layer.

The puzzle pieces may be made from lightweight and sturdy materials such as wood, plastic, or acrylic.

The bottom surface of each puzzle piece may be coated with a chalk-friendly finish allowing for erasing of marks. That is, the puzzle piece itself may come in contact with chalk when placed into the respective indented space wherein coating the puzzle piece with a chalk-friendly finish provides ease of cleaning.

The indented layer may further include an indented space for storing chalk or chalk-like writing implements.

Any writing in the indented space may be erased using a chalkboard eraser or damp cloth.

The chalkboard-based puzzle apparatus may further include a chalkboard eraser or cloth.

The puzzle pieces may comprise at least one of: upper case letters, lower case letters, numbers, words, and geometric shapes.

The printable surface may include markings to aid in printing onto the printable surface. The markings may be visually different to denote different categories.

Provided herein is a printable puzzle apparatus comprising a base including an indented layer comprising a flat board having a plurality of indented spaces, wherein each indented space has a flat bottom surface comprising a re-usably printable material for writing upon with an erasable writing implement, and a plurality of puzzle pieces, wherein each puzzle piece is sized and shaped to match one of the plurality of indented spaces, such that each puzzle piece fits into a respective indented space.

The re-usably printable material may be a dry-erase material, and the writing implement may be a dry-erase marker.

The plurality of indented spaces may comprise indentations in the indented layer, wherein each indentation is a depressed area which can receive a respective puzzle piece of the plurality of puzzle pieces. The bottom surface of each indentation may comprise an insert of dry-erase material.

The plurality of indented spaces may comprise cutouts through the indented layer, wherein the base of the puzzle further includes a printable layer comprising a chalkboard material which is connected to the indented layer such that the printable layer comprises the bottom surface of the plurality of indented spaces, and the printable layer is accessible for writing upon through the cutouts of the indented layer.

Provided here is a method of using a printable puzzle apparatus, wherein the printable puzzle apparatus includes an indented layer with a plurality of indented spaces, and a plurality of puzzle pieces, wherein each puzzle piece fits into a correspondingly sized and shaped indented space, and wherein a bottom surface of each indented space comprises a re-usably printable material, and wherein the method include placing at least one puzzle piece into at least one indented space, removing at least one puzzle piece from at least one indented space, and printing on the bottom surface of at least one indented space with a writing implement, when a puzzle piece is not present in the at least one indented space.

The method may further comprise erasing marks from at least one indented space.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is an exploded view of the three layers of a chalkboard puzzle apparatus; according to an embodiment;

FIG. 2 is a perspective view of a chalkboard puzzle apparatus, according to an embodiment;

FIG. 3A is a top view of a chalkboard puzzle apparatus, according to an embodiment;

FIG. 3B is a top view of the chalkboard puzzle apparatus of FIG. 3A with the puzzle pieces removed, according to an embodiment; and

FIG. 3C is a top view of the chalkboard puzzle apparatus of FIG. 3A, with the puzzle pieces and chalk removed, according to an embodiment; and

FIG. 4 is a flow diagram of a method of possible user interactions with a printable puzzle apparatus, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Provided herein are educational puzzles in the form of a chalkboard puzzle apparatus including an indented layer with indented spaces, printable surfaces within the indented spaces, and puzzle pieces.

In a first embodiment, a printable layer sits underneath the indented layer wherein the indented spaces of the indented layer comprise cutouts into which the puzzle pieces can be placed to sit upon the printable layer. The cutouts are windows to the printable layer wherein a user can write on the printable layer through the cutouts using a writing implement.

In the first embodiment, the printable layer may be a chalkboard layer, and the writing implement is chalk or a chalk pen/marker which can write on the chalkboard.

In a second embodiment, the indented spaces of the indented layer do not pass through the entire indented layer to access a printable layer underneath, but instead are indentations in the indented layer wherein a bottom surface of each indentation is formed from the indented layer and the bottom surface of each indentation has a printable surface. That is, there is no separate printable layer underneath the indented layer. The printable surface may be a chalkboard material surface.

In various embodiments, the indented spaces and puzzle pieces are letters and/or numbers, wherein the user may print the letters and/or numbers onto the chalkboard layer within the indented spaces.

In various embodiments, the apparatus has markings which provide a further visual aid for printing the letters and/or numbers. In some embodiments, the marking may be visually different depending on a category of the shape of the indented space/puzzle piece. For example, if the indented space/puzzle pieces are letters, the vowels may be a different color than the consonants.

The chalkboard puzzle apparatus enables a user to both identify letters and/or numbers (or other shapes, e.g., geometric shapes) of the puzzle pieces which fit into the indented spaces, and to practice writing the letters and/or numbers by following the shape of the indented spaces to write on the chalkboard material.

Combining identification and printing together within the Science of Reading™ framework can build strong, interconnected skills that support both reading and writing. The apparatus provided herein enables a method which helps students internalize letter-sound relationships more efficiently, encourages multisensory engagement, and promotes automaticity—all of which are critical for literacy development.

The use of both puzzle pieces and printable surfaces to interact with the letters, numbers, or other shapes provides improved number sense acquisition (i.e., the ability to identify, understand, and trace or print numbers), improved letter acquisition (i.e., the ability to identify letter and practice letter formation through tracing or printing), improved shape acquisition (i.e., the ability to identify geometric shapes and replicate through tracing), name printing ability (i.e., ability to trace or independently write one's name), and student engagement (i.e., engagement with the toy as measured by attentiveness, active participation, and enthusiasm while interacting with the puzzle).

The chalkboard puzzle apparatus can be used at home, in schools, in daycares, in therapy programs, and in special education programs to provide integration of identification and writing ability for various shapes. Integration of shape matching and identification with printing shapes in the chalkboard puzzle apparatus is a valuable tool in early childhood education to develop foundational skills including number sense, shape recognition, letter identification, and name printing.

Further advantages of the chalkboard puzzle apparatus design include:
i) Successful Printing: The chalkboard layer (chalkboard material within the indented spaces of the puzzle) allows for successful printing of key educational concepts (letters, numbers, shapes)—by not being able to “go out of the lines”, resulting in fine motor skill growth and development for children of all needs and abilities.
ii) Interactive Customization: The chalkboard-based puzzle apparatus offers users the ability to personalize their puzzle-solving experience by writing or drawing directly below the puzzle pieces in the indented spaces.
iii) Reusable and Eco-Friendly: can be made from eco-friendly material and includes a reusable surface (e.g., chalkboard) to allow for repeated use.
iv) Educational Value: The puzzle apparatus encourages creativity, problem-solving, and fine motor skills development, making it suitable for education settings and cognitive therapy programs; combining identification and successful printing yields far greater acquisition in children than identification alone.

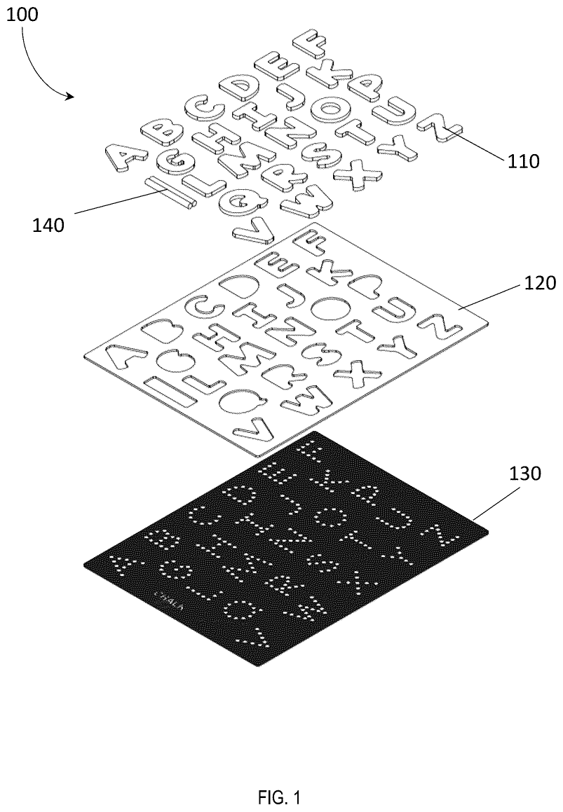

FIG. 1 is an exploded view of the three layers 110, 120, and 130 of a chalkboard puzzle apparatus 100.

The chalkboard puzzle apparatus 100 includes three layers: puzzle pieces 110, an indented layer 120, and a printable layer 130.

The puzzle pieces 110 are upper case English alphabet letters. In other embodiments, the puzzle pieces may be other shapes including, but not limited to, lower case English alphabet letters, upper or lower case letters of other alphabets, numbers, words, geometric shapes, etc.

Each of the indented layer 120 and the printable layer 130 comprise a flat sheet. The indented layer 120 and the printable layer 130 have the same length and width.

The indented layer 120 and the printable layer 130 may have the same or different depths.

In the embodiment of FIG. 1, indented spaces to receive the puzzle pieces 110, take the form of cutouts, through the indented layer 120, in the shape of the puzzle pieces 110.

The printable layer 130 is made of a chalkboard material such that a user can write on the printable layer 130 with chalk 140. The printable layer 130 is flat and smooth to enable writing or printing on the chalkboard material.

In the embodiment of FIG. 1, the indented layer 120 also has a cutout indentation for holding chalk 140.

When the chalkboard puzzle apparatus 100 is assembled, the printable layer 130 is a bottom layer connected to and underneath the indented layer 120. Together the indented layer 120 and the printable layer 130 comprise a chalkboard puzzle apparatus base, wherein the puzzle pieces fit into the indented layer 120 and sit on the printable layer 130. The indented layer 120 and printable layer 130 may be glued together by an adhesive. When the indented layer 120 and the printable layer 130 are connected only the surface of the printable layer 130 which is below the cutouts of the indented layer 120 is visible and accessible by a user.

In some embodiments, the printable layer 130 may only include a writable surface (e.g. chalkboard material) below the cutouts and parts of the printable layer 130 which are covered by the indented layer 120 and not visible or accessible to the user may not have a writable surface.

In other embodiments, the indented layer and printable layer may be connected by other means, such as clips, screws, etc. In other embodiments, the printable layer may be removable by a user, which may result in easier cleaning of the printable layer.

The puzzle pieces 110 are designed to fit precisely into the corresponding cutout on the indented layer 120 and sit on the bottom layer 130. A user can place the puzzle pieces 110 into the corresponding cutouts and remove the puzzle pieces 110 from the cutouts. The depth of the indented layer 120 prevents the puzzle pieces 110 from moving side to side within the apparatus 100.

The puzzle pieces 110 may be made from lightweight and sturdy materials such as wood, plastic, or acrylic. The indented layer 120 may be made from the same material as the puzzle pieces 110 or may be made of a different material.

The printable layer 130 of chalkboard puzzle apparatus 100 includes markings or “tracers” of the upper case English alphabet letters as dots which can be connected using the chalk 140 thereby showing a user how to print the letters of the puzzle pieces. The markings or tracers may be printed or painted onto the surface of the printable layer 130.

The printable layer 130 provides a flat surface for printing.

In other embodiments, the chalk 140 may be another writing implement, for example, chalk-like markers. In other embodiments, the cutout in layer 120 for holding the writing implement may be larger or smaller, may be a different shape, or may not be present.

In other embodiments, the printable layer 130 may be a different re-usable printing material than a chalkboard. For example, the printable layer may be a dry erase board and the writing implement may be dry-erase markers.

In other embodiments, the surface of each puzzle piece may be coated with a chalk-friendly finish, allowing for easy erasing on the puzzle pieces as well as the printable layer.

The chalkboard puzzle apparatus 100 may further include a chalkboard eraser or damp cloth which enables repeated printing on the printable layer or puzzle pieces (when the puzzle pieces are printable as well) to enable replay ability.

The chalkboard puzzle apparatus 100 of FIG. 1 provides a reusable and eco-friendly alternative to traditional puzzles without a chalkboard layer and to printing on paper. The chalkboard puzzle apparatus 100 promotes cognitive development, fine motor skills, language acquisition, and creativity in users, particularly children or adults with fine motor challenges.

The chalkboard puzzle apparatus 100 is suitable for educational settings, cognitive therapy programs, and recreational activities aimed at enhancing problem-solving skills, early developmental skills and fine motor development skills with the addition of the printing component in the puzzle.

The chalkboard puzzle apparatus 100 may be provided to a user with accompanying educational materials or instructions to enhance learning and engagement for children of both special education and mainstream.

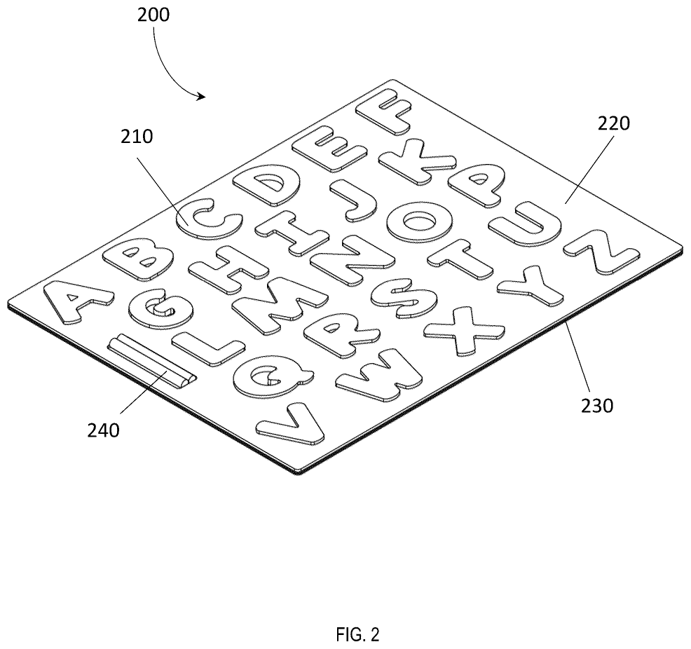

FIG. 2 is a perspective view of a chalkboard puzzle apparatus 200. The chalkboard puzzle apparatus 200 is identical to the chalkboard puzzle apparatus 100 of

FIG. 1.

Chalkboard puzzle apparatus 200 include puzzle pieces 210, indented layer 220, printable layer 230, and chalk 240.

The printable layer 230 is underneath and connected to the indented layer 220.

In FIG. 2, the puzzle pieces 210 are in a first position within correspondingly shaped cutouts in the indented layer 220. The puzzle pieces 210 are upper case (i.e., capital) letters of the English alphabet, and the corresponding cutouts in the indented layer 220 are the same shape but just slightly larger in order to receive the puzzle pieces.

Indented layer 210 also includes a cutout sized and shaped to receive two pieces of standard sized chalk 240.

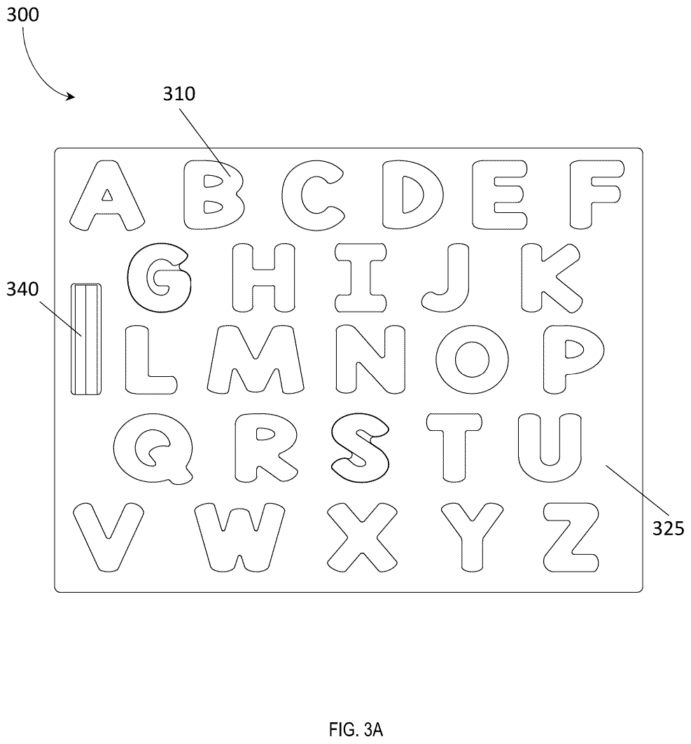

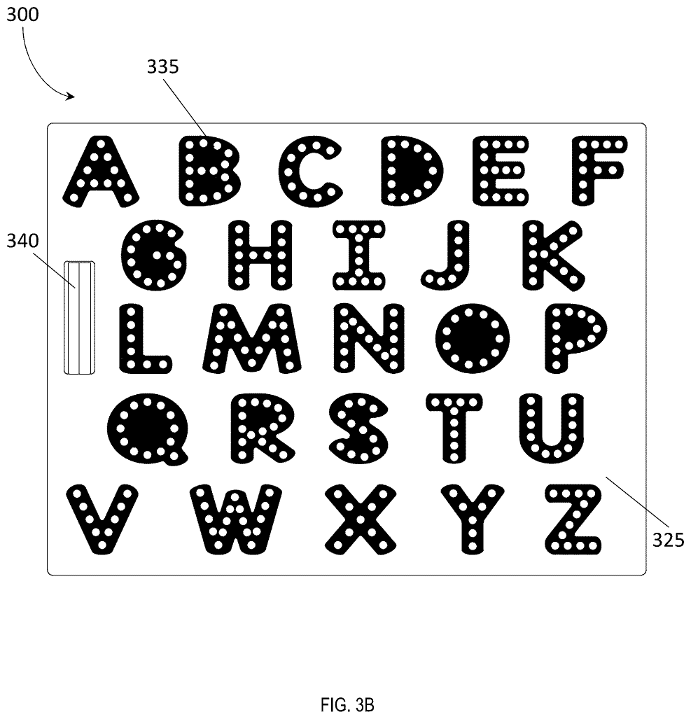

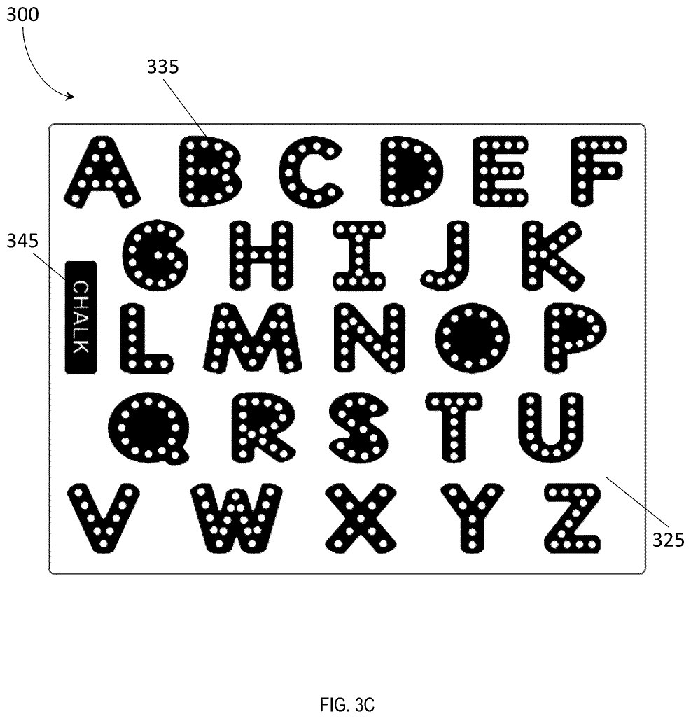

FIG. 3A is a top view of a chalkboard puzzle apparatus 300. Chalkboard puzzle apparatus 300 is similar to chalkboard puzzle apparatuses 100 and 200 of FIGS. 1 and 2, respectively, but the printable surface within the indented spaces is not a separate layer as shown in FIG. 1.

Chalkboard puzzle apparatus 300 includes puzzle pieces 310, indented layer 325, printable surfaces 335 (not shown in FIG. 3A, but shown in FIGS. 3B and 3C), and chalk 340.

In FIG. 3A, the puzzle pieces 310 are in a first position within correspondingly shaped indentations in the indented layer 325. The indentations within indented layer 325 are depressions within the indented layer 325 but do not pass all the way through the indented layer 325 as with the cutouts of FIGS. 1 and 2. The puzzle pieces 310 are upper case (i.e., capital) letters of the English alphabet, and the corresponding indentations in the indented layer 325 are the same shape but just slightly larger in order to receive the puzzle pieces.

Indented layer 325 also includes an indentation 345 sized and shaped to receive two pieces of standard sized chalk 340.

In FIGS. 3A-3C, the base of the chalkboard puzzle apparatus 300 does not comprise two different layers as shown in FIGS. 1 and 2 for chalkboard puzzle apparatus 100 and 200. Instead, the base comprises an indented layer 325 which has indentations to receive the puzzle pieces 310 and the bottom surface of the indentations has a printable surface 335. The printable surface may be an insert of chalkboard material which is placed into or glued onto the surface of the indentations, or the bottom surface of the indentation may be painted with chalkboard paint.

FIG. 3B is a top view of the chalkboard puzzle apparatus 300 of FIG. 3A with the puzzle pieces 310 removed. Printable surfaces 335 are visible and accessible within the indentations of indented layer 325.

The printable surfaces 335 includes markings or “tracers” which are visible to and accessible by a user. The markings includes dots in the shapes of the upper case letters of the puzzle pieces 310 (not shown in FIG. 3B). A user can use the chalk 340 (or another chalk-like writing implement, e.g., a chalk-marker) to trace the letters onto the printable surfaces 335. This allows a user to both identify and interact with the shape of the letters through the puzzle pieces 310 and to practice printing the letters all with the same puzzle.

FIG. 3C is a top view of the chalkboard puzzle apparatus 300 of FIG. 3A, with the puzzle pieces 310 and chalk 340 removed. In the embodiment of FIG. 3C, the indentation 345 has the word “CHALK” printed at the location underneath the indentation in indented layer 325 where the chalk 340 (not shown in FIG. 3C) is to be placed. In other embodiments, a chalkboard puzzle apparatus may not have the word ′CHALK″ printed in the space, the indent for a writing implement may be a different size and shape, or there may not be an indent for a writing implement.

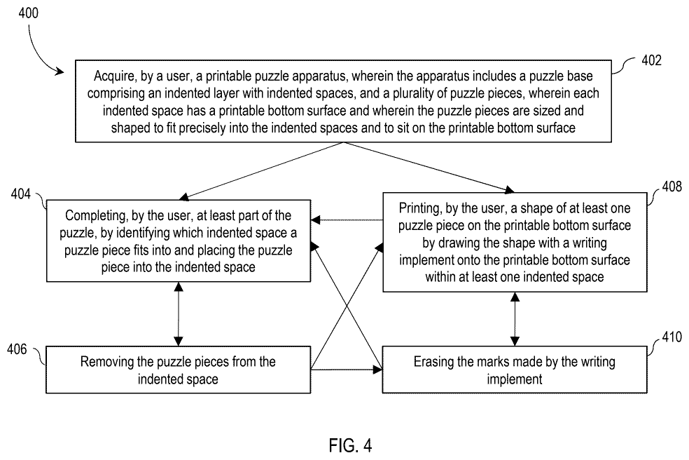

Referring to FIG. 4, shown therein is a flow diagram of a method 400 of possible user interactions with a printable puzzle apparatus.

At 402, a user acquires a printable puzzle apparatus. The printable puzzle apparatus may be similar or identical to any of the chalkboard puzzle apparatuses of FIGS. 1-3C described above, or may be different. The printable puzzle apparatus includes a puzzle base comprising an indented layer with indented spaces and a plurality of puzzle pieces, wherein each indented space has a correspondingly sized and shaped puzzle piece. The indented spaces may be indentations comprising depressed areas of the indented layer wherein each area has a printable bottom surface (as in FIGS. 3A-3C), or the indented spaces may be cutouts through the indented layer to a printable layer underneath the indented layer (as in FIGS. 1 and 2).

The puzzle pieces are sized and shaped to fit precisely into the indented spaces.

The printable layer or printable surfaces comprise a chalkboard material onto which the user can print shapes with a chalk or chalk-like writing implement.

The printable puzzle apparatus may come with a writing implement or the user may provide their own writing implement.

In FIGS. 1-3C, the puzzle pieces were upper case English alphabet letters, but in other embodiment the puzzle pieces may be lower case letters, letters of alphabets of other languages, numbers, geometric shapes, words, etc.

In other embodiments, the printable puzzle apparatus may not include a chalkboard but may include another material which allows for erasing of printing and reusability of the printable layer/surfaces. For example, the printable layer/surfaces may be a dry-erase board material and the writing implement may be dry-erase markers instead of chalk or chalk markers.

At 404, the user completes at least part of the puzzle by identifying which indented space within the indented layer a given puzzle piece fits into and placing the puzzle piece into the indented space.

At 406, the user (or another person, e.g., a parent helping a child wherein the user is a child), removes the puzzle piece(s) from the indented space(s).

At 408, the user prints a shape of at least one of the plurality of puzzle pieces by drawing the shape with a writing implement onto the printable surface within at least one indented space of the indented layer.

At 410, the user (or another person) erases the marks made by the writing implement from the printable surface(s).

When the printable puzzle apparatus includes an indented space for storing a writing implement, e.g., chalk, further actions may include retrieving the writing implement from the puzzle indented space and storing the writing implement within the puzzle indented space.

As shown in FIG. 4, the steps of placing puzzle pieces into indented spaces, removing puzzle pieces from indented spaces, printing shapes on the printable surface(s), and erasing marks from the removable layer may be performed in any number of permutations.

For example, the user may first print the shapes onto the printable surface(s) and then place the puzzle pieces into the indented spaces, then remove the puzzle pieces from the indented spaces, and finally erase the marks from the printable surface(s).

As well, the user may perform the steps for the entire puzzle or for only some of the puzzle pieces at a time. The only actions which cannot be performed out of order are that once a puzzle piece is within an indented space, printing onto the printable surface or erasing marks from the printable surface cannot be performed as the printable surface is covered by the puzzle piece.

The main actions a user can take with the chalkboard puzzle apparatus are to arrange the puzzle pieces onto the corresponding indented spaces (“indentations” or “cutouts”) on the chalkboard puzzle base; solve the puzzle by completing the entire image or pattern depicted by the puzzle; use chalk, chalk-like markers (or other writing implements) to write, draw, or decorate the printable surfaces as desired; and erase the printable surfaces using an eraser or a cloth. These actions enable multiple iterations of puzzle-solving and user customization.

While the above description provides examples of one or more apparatus, methods, or systems, it will be appreciated that other apparatuses, methods, or systems may be within the scope of the claims as interpreted by one of skill in the art.

1. A chalkboard-based puzzle apparatus comprising:
a base including:
an indented layer comprising a board having a plurality of indented spaces, wherein each indented space has a flat bottom surface comprising a printable chalkboard material for writing upon with chalk or a chalk-like writing implement; and
a plurality of puzzle pieces, wherein each puzzle piece is sized and shaped to match one of the plurality of indented spaces, such that each puzzle piece fits into a respective indented space.

2. The chalkboard-based puzzle apparatus of claim 1 wherein the plurality of indented spaces comprise indentations in the indented layer, wherein each indentation is a depressed area which can receive a respective puzzle piece of the plurality of puzzle pieces.

3. The chalkboard-based puzzle apparatus of claim 2 wherein the bottom surface of each indentation is coated with a chalkboard material.

4. The chalkboard-based puzzle apparatus of claim 2 wherein the bottom surface of each indentation comprises an insert of chalkboard material.

5. The chalkboard-based puzzle apparatus of claim 1 wherein the plurality of indented spaces comprise cutouts through the indented layer, and wherein the base of the puzzle further includes a printable layer comprising a chalkboard material which is connected to the indented layer such that the printable layer comprises the bottom surface of the plurality of indented spaces, and the printable layer is accessible for writing upon through the cutouts of the indented layer.

6. The puzzle apparatus of claim 1, wherein the puzzle pieces are made from lightweight and sturdy materials such as wood, plastic, or acrylic.

7. The puzzle apparatus of claim 1, wherein the bottom surface of each puzzle piece is coated with a chalk-friendly finish allowing for erasing of marks.

8. The chalkboard-based puzzle apparatus of claim 1 wherein the indented layer further includes an indented space for storing chalk or chalk-like writing implements.

9. The puzzle apparatus of claim 1, wherein writing in the indented space can be erased using a chalkboard eraser or damp cloth.

10. The chalkboard-based puzzle apparatus of claim 9 further including a chalkboard eraser or cloth.

11. The chalkboard-based puzzle apparatus of claim 1 wherein the puzzle pieces comprise at least one of: upper case letters, lower case letters, numbers, words, and geometric shapes.

12. The chalkboard-based puzzle apparatus of claim 1 wherein the printable surface includes markings to aid in printing onto the printable surface.

13. The chalkboard-based puzzle apparatus of claim 12 wherein the markings are visually different to denote different categories.

14. A printable puzzle apparatus comprising:
a base including:
an indented layer comprising a flat board having a plurality of indented spaces, wherein each indented space has a flat bottom surface comprising a re-usably printable material for writing upon with an erasable writing implement; and
a plurality of puzzle pieces, wherein each puzzle piece is sized and shaped to match one of the plurality of indented spaces, such that each puzzle piece fits into a respective indented space.

15. The puzzle apparatus of claim 14 wherein the re-usably printable material is a dry-erase material, and the writing implement is a dry-erase marker.

16. The puzzle apparatus of claim 14 wherein the plurality of indented spaces comprise indentations in the indented layer, wherein each indentation is a depressed area which can receive a respective puzzle piece of the plurality of puzzle pieces.

17. The puzzle apparatus of claim 16 wherein the bottom surface of each indentation comprises an insert of dry-erase material.

18. The puzzle apparatus of claim 14 wherein the plurality of indented spaces comprise cutouts through the indented layer, and wherein the base of the puzzle further includes a printable layer comprising a chalkboard material which is connected to the indented layer such that the printable layer comprises the bottom surface of the plurality of indented spaces, and the printable layer is accessible for writing upon through the cutouts of the indented layer.

19. A method of using a printable puzzle apparatus, wherein the printable puzzle apparatus includes an indented layer with a plurality of indented spaces, and a plurality of puzzle pieces, wherein each puzzle piece fits into a correspondingly sized and shaped indented space, and wherein a bottom surface of each indented space comprises a re-usably printable material, the method comprising:
placing at least one puzzle piece into at least one indented space;
removing at least one puzzle piece from at least one indented space; and
printing on the bottom surface of at least one indented space with a writing implement, when a puzzle piece is not present in the at least one indented space.

20. The method of claim 17 further comprising erasing marks from at least one indented space.
